(19) United States
(12) Patent Application Publication
(10) Pub. No.: US 2017/0054138 A1
(43) Pub. Date: Feb. 23, 2017

(54) ULTRA-HIGH OUTPUT POWER AND EXTREMELY ROBUST CYCLE LIFE NEGATIVE ELECTRODE MATERIAL FOR LITHIUM SECONDARY BATTERY AND METHOD FOR MANUFACTURING THE SAME, USING LAYER STRUCTURE OF METAL OXIDE NANOPARTICLES AND POROUS GRAPHENE

(71) Applicant: KOREA ADVANCED INSTITUTE OF SCIENCE AND TECHNOLOGY, Daejeon (KR)

(72) Inventors: Jeung Ku KANG, Daejeon (KR); Gyu Heon LEE, Daejeon (KR); Jung Woo LEE, Daejeon (KR); Sang Jun KIM, Daejeon (KR)

(73) Assignee: KOREA ADVANCED INSTITUTE OF SCIENCE AND TECHNOLOGY, Daejeon (KR)

(21) Appl. No.: 14/978,958

(22) Filed: Dec. 22, 2015

(30) Foreign Application Priority Data
Aug. 21, 2015 (KR) 10-2015-0118146

(51) Int. Cl. H01M 4/04; H01M 10/0525; H01M 4/133; H01M 4/48; H01M 4/62

(52) U.S. Cl. CPC H01M 4/0428; H01M 4/483; H01M 4/625; H01M 4/133; H01M 10/0525

(57) ABSTRACT

Disclosed is a negative electrode material for a lithium secondary battery, using a layer structure of porous graphene and metal oxide nanoparticles, with remarkably fast charge/discharge characteristics and long cycle life characteristics, wherein macropores of the porous graphene and a short diffusion distance of the metal oxide nanoparticles enable rapid migration and diffusion of lithium ions. The present invention may achieve remarkably fast charge/discharge behaviors and exceedingly excellent cycle life characteristics of 10,000 cycles or more even under a current density of 30,000 mA·g⁻¹. Accordingly, the structure of the present invention may implement very rapid charge/discharge characteristics and stable cycle life characteristics while having high capacity by combining the structure with negative electrode nanostructures of the porous graphene network structure, and thereby being widely used in a variety of applications.

This application claims priority to Korean Patent Application No. 10-2015-0118146, filed on Aug. 21, 2015 in the Korean Intellectual Property Office, the entire disclosure of which is incorporated herein by reference.

### FIELD OF THE INVENTION

The present invention relates to a negative electrode material of a lithium secondary battery with ultra-fast charge and discharge characteristics and long cycle life characteristics, and a method for manufacturing the same. More particularly, the present invention relates to a technique for synthesis of a composite layer structure of metal oxide and graphene having a three-dimensional shape, which includes pores in different sizes, wherein the formed pores improve accessibility of electrolyte and ions, a graphene support having high electric conductivity in a network form may play a role of facilitating migration of electrons between the metal oxide as an active material and a collector of the electrode. Based on the above-described structural design, the present invention provides an electrode material for a lithium secondary battery, with advantages of possibly charging and discharging within one minute at ultra-high charge and discharge speeds directly related to output power characteristics, and enabling the battery to operate without loss of capacity during an extremely long cycle life.

### BACKGROUND OF THE INVENTION

The present invention proposes a method for synthesis of a graphene network structure having a high conductivity of 900 to 1100 s/m in a three-dimensional shape using a more convenient process with reduced time, as compared to conventional graphene synthesis processes. Further, the present invention proposes a method for synthesis of a composite with a layer structure by depositing metal oxide nanoparticles on a graphene support in a uniform thin film form using a simple drop-wise process. The deposited metal oxide thin film is a thin film formed of nanoparticles connected to each other to generate mesopores between the particles, and plays a role of improving accessibility of the above-described ions and electrolyte. The process proposed in the present invention may enable application of metal oxide, alloy and lithium intermetallic compounds with different constitutional compositions on a graphene structure. Further, other than the network form proposed by the present invention, the present invention may implement the graphene support having a variety of morphologies on the basis of the structure of a catalyst support to grow graphene.

### DESCRIPTION OF THE RELATED ART

A lithium secondary battery, which is one of representative high-capacity energy storage and supply devices, is an electro-chemical energy storage device which enables repeatedly charging and discharging through a reversible electro-chemical reaction, and ensures a more effective use while having higher electric capacity than other energy storage devices. In a wide range of applications including a small mobile device, the lithium secondary battery is used as the energy storage and supply device. In recent years, a large number of research and developments have been executed in various devices and systems such as a portable electrical device, electric car, smart grid, and the like, as a next-generation technique. However, the energy supply and storage devices have much difficulty in implementing the above-described techniques due to a limitation in performances thereof. The lithium secondary battery has been mostly used in specified applications requiring high capacity energy storage, while in alternative applications requiring high output power characteristics along with low capacity and high charge and discharge speeds, a capacitor has been mostly used. However, the performance thereof is concentrated in respective characteristics such as high capacity or high output power, and thus it is not possible to satisfy the performance required in the next generation techniques. Therefore, currently, there are limitations in development of technical fields which require a high performance energy storage and supply device. In order to overcome the limitations, it is an unavoidable condition to develop the next generation energy storage devices capable of satisfying characteristics such as high capacity, high charge and discharge speeds, stability, and the like.

Efficiency of the lithium secondary battery may be determined by physical properties including, for example, electric conductivity, ionic conductivity, chemical/structural stabilities, etc., of an active material used as an electrode material such as metal oxide, silicone, graphite, carbon, and the like. In order to improve these physical properties, a great deal of research and developments have been executed. Among these, the carbon or silicon-based material exhibits high capacity performance, however, an increase in volume due to crystal and lattice distortion generated during electro-chemical reaction for lithium intercalation and adsorption or desorption, and electrode distortion due to the expanded volume have caused a problem such as a significant deterioration in energy storage performance and cycle life. For these reasons, although the metal oxide has attracted attention in an aspect of chemical/structural stabilities, it also has a problem entailed in the limitation of energy storage efficiency due to low electric conductivity and ionic conductivity.

According to conventional arts, a method for improving the electric conductivity by combining various structures such as carbon nanotube, graphene, carbon nano-ribbon, etc. with active materials, a method for increasing ionic conductivity by synthesizing a variety of structures having pores, or the like, have been developed.

The present inventors have studied repeatedly with taking an aim to overcome the limitations in conventional energy storage systems using various metal oxide structures. In other words, in order to noticeably improve utility of the lithium secondary battery used in the limited applications due to limitations in high capacity characteristics, the present inventors have developed a composite layer structure including a thin film made of metal oxide nanoparticles having mesopores as well as porous graphene in a three-dimensional network form, with reduced loss in capacity and excellent cycle life characteristic, while enhancing both physical properties of low ionic conductivity and electric conductivity which may limit charge/discharge speed characteristics, and thereby completing the present invention. When using the composite layer structure according to the present invention, the following effects may be expected: 1) due to an increased specific surface area, the number and space of active sites for an electron-transport reaction are increased; 2) very small metal oxide nanoparticles and pores formed therebetween increase accessibility of electrolyte while improving ionic conductivity; 3) the electrode may have enhanced volumetric capacity due to not using any adhesive material or conductive agent; 4) instead of chemically synthesized graphene through an oxidation-reduction reaction and other carbon-based additives, alternative graphene having remarkably superior electric conductivity synthesized by chemical vapor deposition is used, so as to further noticeably increase the electric conductivity.

Conventional art in relation to the present invention has not yet been disclosed, however, Korean Patent Registration No. 10-1406371 (entitled “a metal or metal oxide/graphene nano-composite having a three-dimensional structure, and a method for manufacturing the same”) describes uniformly combining metal or metal oxide in the form of nanoparticles having a uniform size on a graphene surface to effectively control re-lamination and coagulation of graphene, thereby desirably enhancing the electric conductivity, charge/discharge characteristics and cycle life characteristics, compared to the conventional batteries. In addition, Korean Patent Registration No. 10-1430405 (entitled “a negative electrode material for a lithium ion battery, and a method for manufacturing the same”) describes a negative electrode material for a lithium ion battery, which includes a graphite layer formed on at least one surface of a support, and cracks generated on the surface of the graphite layer.

Further, Korean Patent Laid-Open Publication No. 10-2014-0008953 (entitled “a slurry including graphene for a secondary battery, and the secondary battery including the same”) describes the slurry for a secondary battery, which includes a negative electrode active material containing LixMyOz, a binder, and a conductive agent containing graphene. Additionally, there are other patents regarding the negative electrode material for a lithium secondary battery, for example: Korean Patent Registration No. 10-1355871 discloses a method for manufacturing a lithium titanium oxide-graphite composite, including synthesis of lithium titanium oxide and graphite oxide through a hydro-thermal reaction, the lithium titanium oxide-graphene composite prepared by the above method, and an electrode material including the lithium titanium oxide-graphene composite described above; Korean Patent Registration No. 10-1393734 (entitled “a method for manufacturing a negative electrode material in a porous network structure for a lithium secondary battery, and the lithium secondary battery manufactured using the same”) describes a method of preparing a negative electrode material for a lithium secondary battery, including: applying copper nanoparticles mixed in an organic solvent on a substrate; evaporating the organic solvent by performing a first heat treatment; and sintering the negative electrode remained after the evaporation by performing a second heat treatment; and Korean Patent Registration No. 10-1400994 (entitled “an electrode for a high capacity lithium secondary battery and the lithium secondary battery including the same”) describes a negative electrode for a lithium secondary battery, which includes metal or sub-metal nanoparticles capable of forming an alloy with lithium in carbon nanotubes (CNT) or carbon nanofibers (CNF), and the lithium secondary battery including the same. However, these conventional arts are generally different from the present invention in terms technical configurations thereof.

### SUMMARY OF THE INVENTION

A lithium secondary battery using a metal oxide electrode material has lower limited capacity than a carbon and silicon-based electrode material, however, is structurally stable and relatively safe against danger such as exploration and has a merit of long cycle life. In recent years, in order to achieve various electronic devices and systems including an electric car spotlighted as a next generation transport means, high output power characteristics of an energy storage device, that is, high charge/discharge speeds are required. Although previous lithium secondary batteries were studied and developed with focusing the high capacity and stability characteristics, there is a problem that these necessary conditions are not satisfied due to limitation in the performance thereof. Conventional carbon and silicone-based electrode materials which are widely and commercially available in the market may have high capacity, but, entail a drawback of short cycle life due to the expansion of volume. Further, under a high current density condition, almost 90% or more loss of capacity occurs and causes a crucial problem that the above materials cannot be used in some applications requiring high output power. In regard to the metal oxide electrode, a method for improving electron mobility by mixing metal oxide with a carbon or metallic material having high electric conductivity to compensate low electric conductivity has been developed. Similarly, there have been many attempts to solve a problem of low electrolyte accessibility using a composite structure of some materials having different morphologies from zero-dimensional to two-dimensional shapes, so as to improve the performance thereof. However, in spite of such efforts, it has not yet reached desired performance in recently advanced electrical devices, therefore, to develop a novel energy storage and supply device becomes more important.

The present inventive method may be conducted by three separate sub-processes of: synthesizing a graphene structure in a network form; synthesizing a colloidal solution of metal oxide nanoparticles; and depositing the metal oxide nanoparticles on the graphene structure. Such a synthesis of the graphene structure may be performed by chemical vapor deposition (CVD) generally used in the art. In order to reduce a time for raising a temperature and cooling, which is detrimental for a process time of graphene synthesis, a modified rapid thermal CVD (RTCVD) system was designed and utilized (see FIG. 1). The CVD system used in a process of growing the graphene may generally include a heating zone and a cooling zone, and have a configuration in which a screw bar-shaped moving part is disposed at a lower end of a heater. This system is operated on the basis of a principle that the heater moves between the heating zone and the cooling zone while maintaining a preset temperature. In the case of CVD having a heater fixed thereto, a high temperature of 1,000° C. is used in each of separate graphene growth processes and quite a long time is required for raising the heater to the above temperature and cooling the same. On the other hand, a system used in the present inventive process requires a total of 30 minutes or less to raise a temperature and generate heat, therefore, can reduce the process time. Since the temperature raising time is considerably reduced by moving the heater, and a cooling pan is used while a portion of a sample located in the cooling zone is exposed to the atmosphere, the cooling process may be more easily conducted to attain an advantage. After the growth of graphene using Ni foam catalysts, the catalysts used for graphene growth may be removed through etching to thus may be used as a structure. A variety of methods such as hydro-thermal synthesis, solvent thermal synthesis, sol-gel synthesis, etc., may be used to synthesize nanoparticles and prepare a colloidal solution including the nanoparticles uniformly dispersed in a solution. Using the material prepared according to such two processes as described above, the solution is deposited on the surface of the graphene structure by a drop-wise process, while controlling a concentration of the metal oxide colloidal solution.

The present invention is not particularly limited to the above-described different processes, however, it is possible to synthesize a graphene structure with different sizes and morphologies depending upon types of catalysts used in the graphene growth. Further, according to types of the metal oxide which is the active material for electro-chemical reaction, the present invention may be applicable to both of the positive and negative electrodes for a lithium secondary battery having high efficiency and various characteristics. Other than the lithium secondary battery field, the present invention discloses a technique that may be utilized in a very wide range of applications using a metal oxide semiconductor and a carbon material, such as a flexible conductive board and energy storage device (flexible electrode, capacitor, etc.), a water decomposition electro-chemical catalyst electrode for a fuel cell, a solar energy conversion photocatalyst, an electrode of a dye-sensitive solar cell, an electro-chemical gas sensor, and the like.

The present invention describes a layer structure, fabricated by forming titanium dioxide-metal oxide crystals with a small size of 4 to 10 nm in a thin film form having open mesopores with a size of 2 to 8 nm on the graphene of a network form having macropores in a three-dimensional shape while having high conductivity. By using this structure, there is provided a method for preparing an electrode material of a lithium secondary battery without any adhesive and conductive agent, wherein high capacity may be maintained under a high current density condition, and the lithium secondary battery may be operated during quite a long cycle life. This is a technique that may synthesize a structure capable of greatly improving both physical properties of low electric conductivity and ionic conductivity of the metal oxide by a relatively fast and simple process, to thus noticeably maximize the performance of the liquid secondary battery.

As shown in FIG. 2(a), a the inventive product was fabricated in a disk shape having a size of 0.7 to 0.9 cm diameter and 0.2 to 0.4 mm thickness. In this case, the fabricated product is adapted to have a principle that: titanium dioxide nanoparticles synthesized by hydro-thermal synthesis are uniformly deposited on an entire of a graphene structure in a three-dimensional network form by a drop-casting method to form mesopores between the nanoparticles connected to each other; and then, lithium ions migrate between the formed mesopores and, at the same time, move along the graphene structure. The graphene structure synthesized by chemical vapor deposition to thus achieve very high crystallinity and electric conductivity while having reduced defect, may be directly linked to a current collector to thus achieve remarkably rapid migration of electric charge, and enable easy access and penetration of electrolyte into the open mesopores of the titanium dioxide nanoparticles, thereby enhancing ionic conductivity. In the case of an active material having relatively a large size, lithium cannot be intercalated into a central part of a crystal under a high current density condition, hence resulting in a decrease in a concentration of lithium ions over time, which in turn, causes a problem of extending a diffusion time of the lithium ions. On the other hand, in the case of nanoparticles having a very small size, a distance from the surface to the central part of the crystal is short, and thus, lithium can be intercalated over an entire of the crystal within a very short time. Accordingly, in general, more efficient energy storage can be achieved. Likewise, a specific surface area may also be wider than that of the conventional two-dimensional thin coating type electrode, due to active material particles having a small particle size as well as a three-dimensional pore structure. Therefore, it is possible to very efficiently secure a lots of active sites for a reaction between the electrolyte and the lithium ions and nanoparticles, thereby maximizing ionic conductivity which greatly influences upon output performance of the lithium secondary battery. Further, in general, a conductive agent and an adhesive used as constitutional materials of an electrode have a drawback of inhibiting rapid migration of the electrolyte or electric charge between the active material and the current collector. However, the electrode material of the present invention does not include the conductive agent and adhesive added thereto, therefore, it is possible to overcome demerits entailed in the electrode material made of general slurry. Consequently, as compared to the electrode of the existing typical secondary battery, the electrode material of the present invention may include a specific structure to achieve desired performance such as higher discharge/discharge speed and longer cycle life characteristics.

In order to evaluate the performance of the present invention, a coin battery including a lithium foil counter electrode as well as the inventive electrode was fabricated and electro-chemical reaction performance of the lithium secondary battery was confirmed. First, in order to identify behavior characteristics of lithium intercalation/deintercalation, a porous graphene-titanium dioxide nanoparticle sample was subjected to cyclic voltage-current measurement under a voltage window condition of 1 to 3 V to Li/Li+ energy level (FIG. 8 (a)). As a result thereof, peaks were observed at a specific energy level of 1.7 V for a positive electrode reaction and 2.0 V for a negative electrode reaction, respectively. It could be seen that the observed results are substantially coincident with the reaction in anatase phase titanium dioxide. Referring to the specific capacity measurement curve during charging/discharging under a condition of different current densities (FIG. 8 (e)), it could be seen that, when comparing the electrode fabricated using a single sample of the titanium dioxide nanoparticles (TiO₂ NP) with the electrode having a composite layer structure composed of a porous graphene structure and titanium dioxide (TiO₂ NP PG), there is a clearly distinguishable difference in the specific electric capacities thereof. For the titanium dioxide nanoparticle electrode, lithium intercalation/deintercalation was almost not executed due to an increase in current density. However, it could be seen that the present invention may maintain high capacity even in a high current density and have little loss in electric capacity caused by an increase in current density. Further, referring to a capacity analysis curve to voltage of the porous graphene-titanium dioxide nanoparticle structure sample (FIG. 8(f)), it could be seen that, when the current density is increased from 100 to 10,000 mA·g⁻¹ by about 100 times, about 60% or more of the original capacity is maintained. This result demonstrates that the capacity of 150 mAh·g⁻¹ can be charged/discharged within about one minute. Further, in regard to the measurement of cycle life performance (FIG. 9 (c)), it could be seen that the secondary battery operated in a highly stable manner while maintaining the capacity at a high level with very little loss thereof during up to 10,000 cycles even under a condition of extremely high current of 30,000 mA·g⁻¹. Further, it was also demonstrated that coulombic efficiency is maintained to nearly 100%. As shown in FIGS. 9 (a) and (b), excellent cycle life characteristic to extremely long time results from an effect of the mesopores formed between the titanium dioxide nanoparticles which have a very small size and are formed on the porous graphene. This means that, when the mesopores directly contact with the graphene having electric conductivity, a shape of the mesopores may be maintained well. The above result demonstrates that an intercalation/deintercalation reaction of the lithium ions occurs between open mesopores present between the titanium dioxide nanoparticles on the surface of a graphene network form free from the conductive agent, thereby enabling fast ion conduction. In order to analyze the causes of such a difference in performance as described above, electro-chemical impedance was further analyzed (FIG. 10). As a result of the analysis, it could be seen that the porous graphene-titanium dioxide nanoparticle structure sample has considerably decreased resistant value expressing the resistance to charge migration and electrolyte migration at an interface between the electrode and the electrolyte, compared to a single sample of titanium dioxide nanoparticles. According to this finding, it could be understood that the electrolyte and charge easily migrate with reduced interfacial resistance, thus improving the performance. From the above results, it could be seen that the structure of the present invention may achieve the performance satisfying all conditions for commercialization of secondary batteries, and charge/discharge is possible within a very short time, and thereby it is possible to expect the structure to be utilized in a variety of applications, and have a stable and long cycle life, which is remarkably excellent performance, in particular, 100 to 1,000 times as high as that of the existing typical secondary batteries.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is (a) a view of a schematic structure; and (b) a photograph of an actual RTCVD system used in a graphene growth process among subsidiary processes of the present invention;

FIG. 2 is (a) a photograph of an actual inventive product, (b) and (c) diagrams showing a structure and operational principle (bright blue: electron, yellow: lithium ion, bright gray: metal oxide nanoparticle); and (d) a scanning electron microscopic (SEM) image with a transmission electron microscopic (TEM) image of the inventive product containing lithium intercalated therein (SEM and TEM size rulers indicate 50 μm and 2 nm, respectively);

FIG. 3 is TEM images of titanium dioxide metal oxide nanoparticles used in the present invention, which are diagrams showing the nanoparticles formed with an average size of about 6 nm;

FIG. 4 is an SEM low-magnification image of a porous graphene-metal oxide structure sample;

FIG. 5 is (a) images showing results of low-magnification SEM and energy dispersive spectroscopy analysis, (b) an image showing a high-magnification cross-section; and (c) and (d) a TEM image and a crystal lattice diffraction pattern image with different magnifications, respectively;

FIG. 6 is graphical diagrams respectively illustrating results of (a) thermogravimetric analysis, (b) X-ray photoelectron spectroscopy, (c) X-ray diffraction analysis, (d) Raman spectroscopic analysis, (e) comparison analysis of gas adsorption isotherm, and (f) comparison analysis of pore size alignment, in regard to both of a porous graphene-titanium dioxide nanoparticle sample and a single porous graphene sample;

FIG. 7 is graphical diagrams illustrating results of X-ray photoelectron spectroscopic analysis, in regard to both of the porous graphene sample and the porous graphene-titanium dioxide nanoparticle sample;

FIG. 8 is graphical diagrams respectively illustrating (a) cyclic voltage-current curves, (b) results of lattice diffraction pattern analysis before and after lithium intercalation, (c) and (d) Li 1 s and Ti 2 p spectra of X-ray photoelectron analysis before and after lithium intercalation, in regard to the porous graphene-titanium dioxide nanoparticle structure, (e) specific capacity measurement curves under a condition of different current densities, in regard to the porous graphene-titanium dioxide nanoparticle sample and the single titanium dioxide nanoparticle sample, and (f) capacity curves to voltages of the porous graphene-titanium dioxide nanoparticle sample (unit of each current density is denoted by mAh·g⁻¹);

FIG. 9 is diagrams respectively illustrating (a) an SEM image and (b) a TEM image of the porous graphene-titanium dioxide nanoparticle sample, which are images for describing the observed results of mesopores facilitating the lithium intercalation, and (c) comparison curves of specific capacity cycles of the porous graphene sample, the titanium dioxide nanoparticle sample and the porous graphene-titanium dioxide nanoparticle sample, respectively, and a coulombic efficiency curve of the porous graphene-titanium dioxide nanoparticle sample;

FIG. 10 is a graphical diagram illustrating electro-chemical impedance analysis curves of the porous graphene-titanium dioxide nanoparticle sample and the single titanium dioxide nanoparticle sample; and

FIG. 11 is (a) an SEM image and (b) a TEM image of the porous graphene-titanium dioxide nanoparticle structure sample after completing the examination of a lithium intercalation/deintercalation reaction repeated by 10,000 times (size rulers indicate 100 nm and 20 nm, respectively).

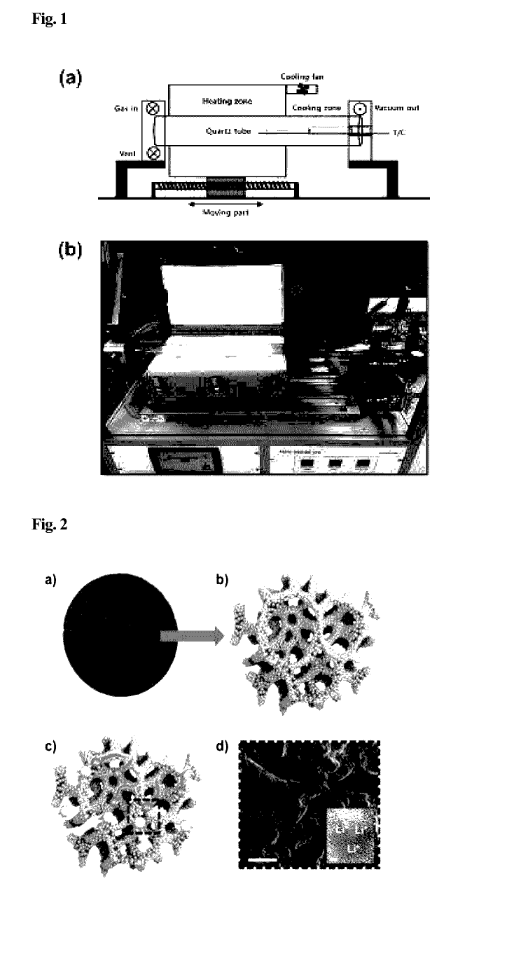

### DETAILED DESCRIPTION OF THE INVENTION

The present invention proposes a synthetic method of a structure with improvement of output power characteristics and cycle life characteristics of a lithium secondary battery, including: depositing metal oxide nanoparticles having a very small size in a thin film form on a porous graphene structure of a three-dimensional form; and then forming mesopores between the nanoparticles, so as to enhance low electric conductivity and ionic conductivity of metal oxide materials.

The technique proposed by the present invention is not particularly limited to titanium dioxide (TiO₂) substances illustrated by the following examples, but, may be widely employed in a lithium secondary battery made of any metal oxide material that exhibits characteristics of oxide-based ceramics or semiconductors and includes at least one element selected from a group consisting of Ti, V, Mn, Fe, Co, Ni, Cu, Zn, Al, Si, Ge, Nb, Mo, Sn and Sb, so as to improve the performance thereof.

### Example 1

After cutting a nickel foam into a size of 0.8 cm and washing the same by using an ultrasonic disperser containing ethanol therein, the ethanol remained on the nickel foam with a nitrogen gas and the nickel foam was dried in the atmosphere. Then, a nickel catalyst was moved to a quartz tube in RTCVD shown in FIG. 1, and a sample (graphene) was placed on a sample support. After placing the sample, a chamber was under a vacuum state with a pressure of 1.0×10⁻³ Torr or less, and a heating zone was heated to a temperature of 900 to 1,100° C. while flowing an argon/hydrogen (500/200 sccm) mixed gas into the same. Next, after growing the graphene while flowing a methane gas therethrough, the heating zone was rapidly moved to its original position and cooled to a temperature of 190 to 210° C. within 4 to 6 minutes.

Thereafter, the temperature of the heating zone was raised to 900 to 1,100° C. A heater was moved to the sample support direction, in order to set up a temperature of the sample support part to 1,000° C. within 7 minutes. Next, the graphene was grown for about 10 minutes while flowing the methane gas therethrough. Thereafter, the heating zone was cooled to a temperature of 190 to 210° C. within 4 to 6 minutes by moving the same to its original position. In a final etching process, the sample containing the grown graphene was put in 3 molar concentration (3M) hydrochloric acid and treated to remove the nickel catalyst at a temperature of 60 to 80° C. for 5 to 7 hours.

### Example 2

Titanium dioxide nanocrystals were put in a solution including 0.1 ml of tert-butylamine, 10 ml of water, 0.1 g of Ti-propoxide, 6 ml of oleic acid and 10 ml of toluene in a PTFE-autoclave, heated at a temperature of 180° C. in an oven for 6 hours, and then, slowly cooled in the atmosphere. The supernatant only was separated from the solution, diluted several times with methanol, dried, and then, dispersed in toluene, resulting in a product in a colloidal solution state.

### Example 3

Titanium dioxide nanoparticles synthesized above were deposited on a graphene structure after controlling a concentration thereof by a drop-casting method. Then, the above material was heated at a temperature of 430 to 470° C. for 1 to 1.5 hours in the atmosphere, so as to deposit the nanoparticles on the graphene structure in a uniform thin film form. As described above, using a layer structure of the porous graphene and metal oxide nanoparticles, a negative electrode material for a lithium secondary battery was prepared.

### Experimental Example 1

An assembly formed of 2320 type coin cells was used for electro-chemical analysis. These coin cells were assembled using a Celgard 2400 separation membrane and lithium foil counter/reference electrodes. A porous graphene-titanium dioxide nanoparticle structure synthesized as a working electrode was directly used without addition of any conductive agent and adhesive. A control sample was prepared in a slurry form by adding a control active material, super P (conducting carbon) and polyvinylidene fluoride (PVDF) in a weight ratio of 80:10:10 to N-methyl-2-pyrrolidinone (NMP). Then, the slurry was applied to a copper foil through a doctor blade coating process, followed by drying the same in a vacuum oven at a temperature of 70° C. for 12 hours. As an electrolyte, a reference organic electrolyte, that is, 1M LiPF6 dispersed in a solution of ethylene carbonate (EC) and diethyl carbonate (DEC) in a volume ratio of 1:1 was used. All steps for assembling a cell were executed in a glove box filled with an argon gas having water and oxygen contents of 1 ppm or less. Constant current was measured using a secondary battery driving device at room temperature, and cyclic current measurement and electro-chemical impedance analysis were performed by a potential variable/impedance analyzer at a velocity of 0.1 mV·S⁻¹ under conditions of 1V to 3V voltage, 5 mV amplitude and 0.01 Hz to 1000 KHz frequency.

Morphology and structure of the sample were analyzed by using instruments of a scanning electron microscope (SEM) and a transmission electron microscope (TEM), and an electron energy-loss spectroscopy equipped in the TEM instrument was utilized for analyzing an electron structure of the sample. X-ray lattice diffraction was measured at a 2θ angle range of 10 to 70°. In an analysis for chemical status of the surface of the sample, X-ray photoelectron spectroscopy was used. Further, a Raman spectrometer equipped with an argon ion laser at a wavelength of 514.5 nm was used to analyze crystallinity of the sample depending on a vibration mode of molecules. Further, thermal stability and weight ratio were analyzed by utilizing thermogravimetric analysis under conditions of a temperature ranging from 20 to 1100° C., a temperature elevation rate of 5° C./minute, and air gas introduction. In addition, in order to measure the electric conductivity, surface resistance and variable potential were measured using a four-point probe connected to a current generator. For analyzing a pore structure, nitrogen adsorption/desorption analysis was performed using a Brunauer-Emmett-Teller (BET) device at a temperature of 77K.

### Experimental Example 2

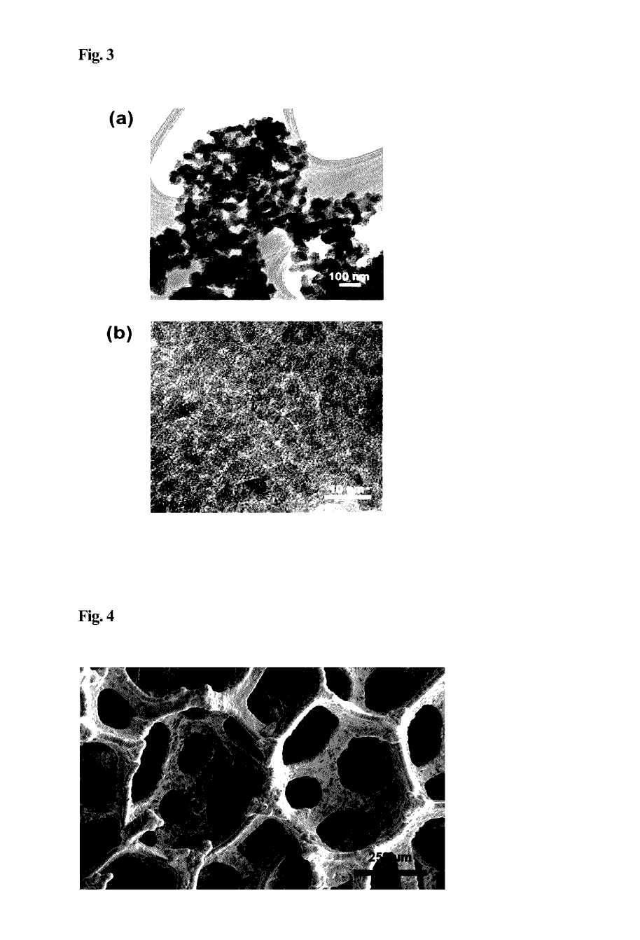

Similar to the structure of the present invention observed through the SEM, TEM and energy dispersive spectrometry (EDS) (FIGS. 3, 4 and 5), it could be seen that titanium dioxide nanoparticles were deposited in a thin film form on a graphene support having pores of 40 to 60 μm and a size of 15 to 25 μm width, and had a constitutional composition made of carbon, titanium and oxygen. From a photograph taken a side of the structure, it could be seen that the titanium dioxide thin film was formed in a thickness of 15 to 25 nm. Further, SEM and lattice diffraction pattern analysis demonstrated that titanium dioxide nanocrystals having a size of 4 to 10 nm were highly uniformly deposited on a single layer graphene having a hexagonal lattice structure. From the TEM lattice spacing analysis and lattice diffraction pattern analysis, it was also found that the titanium dioxide nanoparticles have an interplanar (lattice) distance of 0.351 nm corresponding to a face 101 of titanium dioxide anatase phase. Further, it could be directly observed that both of the graphene and the titanium dioxide nanocrystals have high crystallinity with reduced defects.

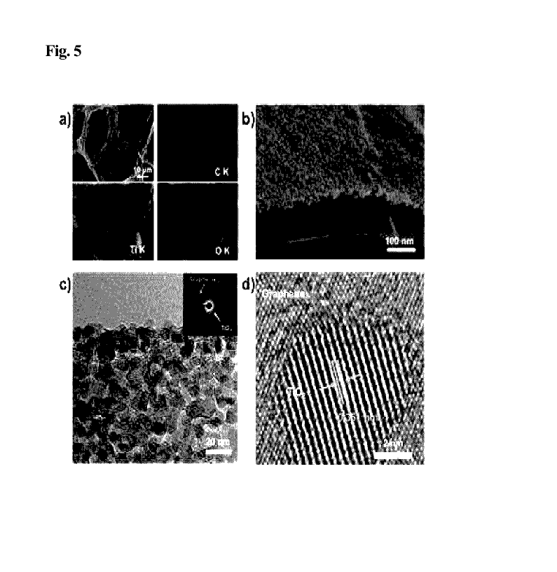

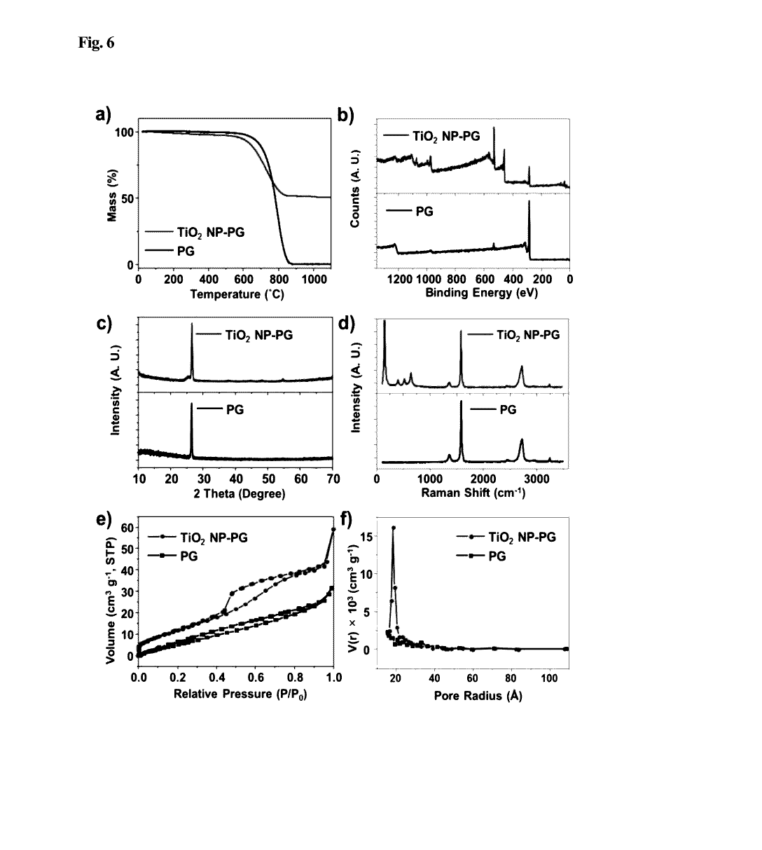

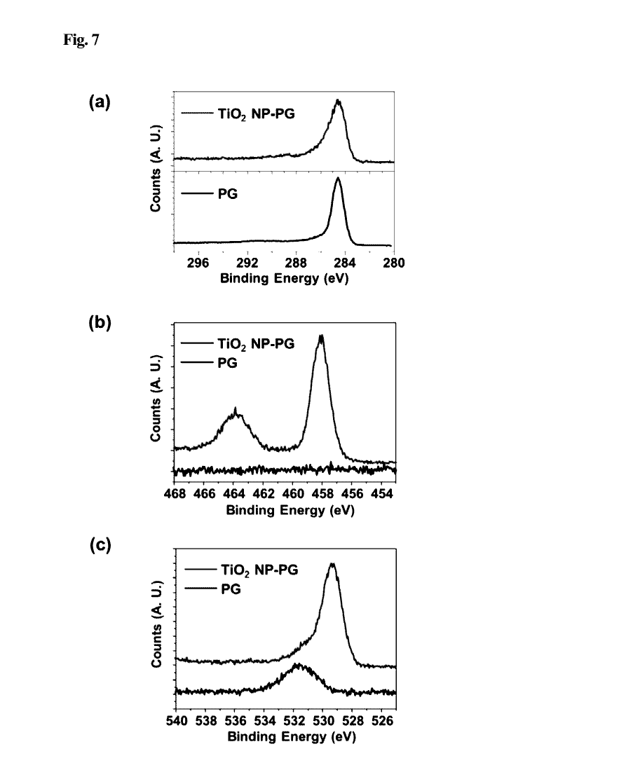

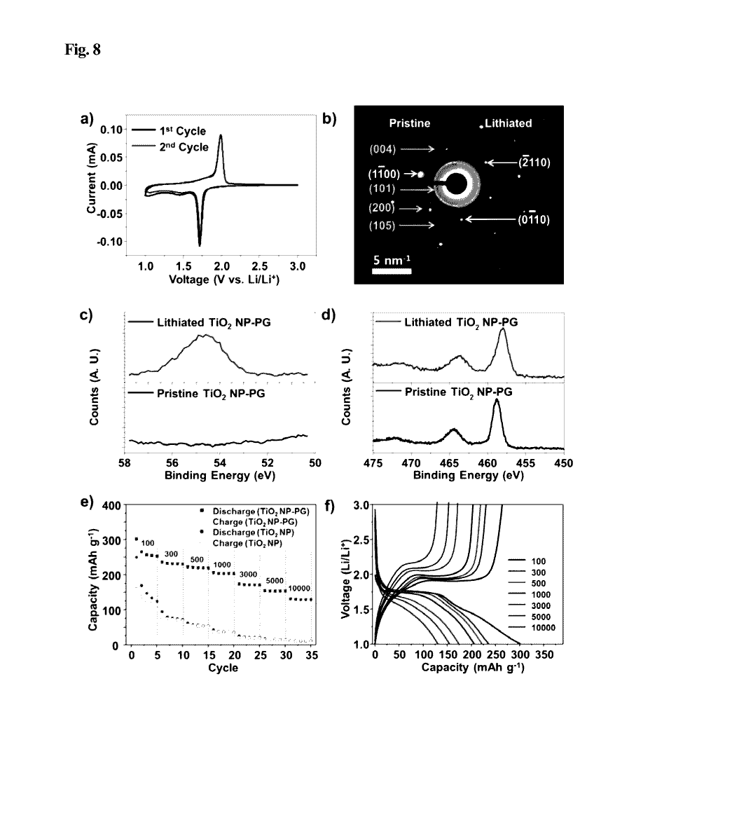

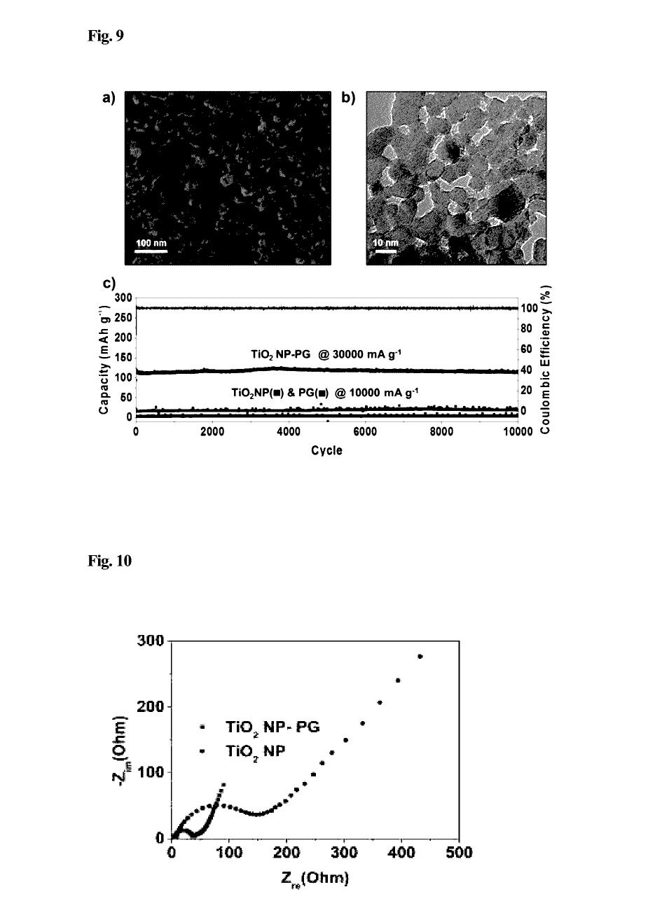

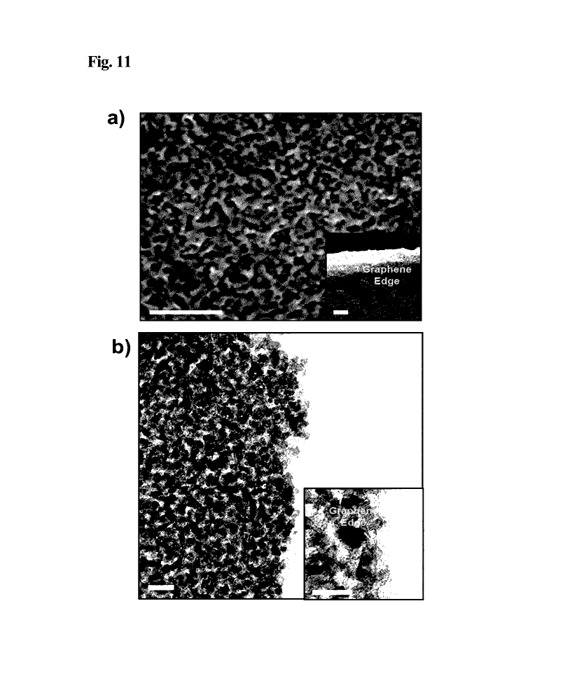

Through thermogravimetric analysis (FIG. 6(a)), it could be seen that sublimation of the porous graphene is the most active around 800° C., and completed at 876° C. This result indicates that thermal stability is noticeably excellent due to the high crystallinity of the graphene, and is a physical property more excellent than the graphene synthesized by a chemical reaction. In the case of the porous graphene-titanium dioxide nanoparticle sample, a sublimation temperature and a sublimation completing temperature are 742° C. and 840° C., respectively, which are slightly decreased as compared to the above case. The reason of this fact was revealed because the titanium dioxide nanoparticles accelerate oxidation of the graphene, and a deposit amount of the titanium dioxide nanoparticles on the graphene was about 51% in a weight ratio. Further, by controlling a concentration of the titanium dioxide nanoparticle solution, the deposit amount may be easily controlled. In order to identify chemical state of the surface of the sample, an X-ray photoelectron spectrometer was used. In survey comparison analysis of the porous graphene sample and the porous graphene-titanium dioxide nanoparticles (FIG. 6 (b)), it was observed that the porous graphene sample has a sharp (high) carbon is peak at 284 eV and a dull (low) oxygen is peak at 530 eV. For the sample including the deposited titanium dioxide nanoparticles, clear titanium 2 p peak and oxygen is peak were observed at 460 eV. These results are substantially coincident with the results of energy dispersive spectroscopy, and demonstrate successful combination of titanium dioxide nanoparticles with the porous graphene network structure. In order to identify in more details, the elements, that is, carbon, oxygen and titanium were analyzed as shown in FIG. 7. For the porous graphene sample, carbon is peak indicating strong double bond or single bond of carbons on the surface of graphene was found at 284.6 eV. On the other hand, for the porous graphene-titanium dioxide nanoparticle structure sample, peaks corresponding to carbon-oxygen single bond and carbon=oxygen double bond were observed at 284.8 eV and 286.4 eV, respectively. Further, the peak indicating carbon-oxygen single bond was also found at 288.5 eV. Such a variation of carbon 1 s peaks is caused by the titanium dioxide nanoparticles bound to the surface of graphene, and demonstrates that carbon-oxygen-titanium bond is formed during a heat treatment process. In addition, titanium 2 p^{1/2} and 2 p^{3/2} peaks corresponding to typical spin-orbital separation of titanium dioxide could be seen at the binding energies of 458.1 eV and 463.9 eV which were not found in the porous graphene sample. A sharp peak at the binding energy of 592.4 eV and a dull peak at the binding energy of 531.2 eV, which were found in the titanium dioxide nanoparticle structure sample and indicate titanium-oxygen and carbon-oxygen bonds, respectively, were also observed. This result means that the titanium dioxide nanoparticles in an anatase phase have titanium-oxygen bond as well as high crystallinity, while the porous graphene has carbon-oxygen bond at the surface thereof. Using X-ray diffraction pattern analysis and Raman spectroscopy (FIGS. 6 (c) and (d)), the porous graphene and the porous graphene-titanium dioxide nanoparticle structure were subjected to comparison analysis. As a result of the comparison analysis, a peak corresponding to an interlayer distance of the graphene equal to about 3.4 Å and an additional peak of the titanium dioxide nanoparticle at an angle of 26° were observed by the X-ray diffraction pattern analysis. The reason why the peak of the titanium dioxide nanoparticle is quite smaller than that of the porous graphene, was identified because the particle has a considerably small size. Further, it could be seen that a crystalline structure of titanium dioxide is the anatase phase (JCPDS#21-1272) corresponding to surfaces 101, 004, 200, 105 and 211. Raman spectroscopic analysis result demonstrates that, in the case of the porous graphene, graphene D, G, D* bands were observed at about 1360, 1580 and 2550 cm⁻¹ positions, which are the substantially same as that generally known in the art. Further, it could be seen that the above graphene has excellent crystallinity and G/D of 12.5 since it was synthesized at a high temperature, as compared to reduced graphene oxide which was synthesized through chemical reduction and has G/D ratio of about 2.32. Likewise, the porous graphene-titanium dioxide nanoparticle structure has also G/D ratio of 11.6 due to a miner change in characteristics of the graphene. In addition, peaks indicating a vibration mode of atoms in the titanium dioxide anatase phase in a tetragonal system were observed at 144, 197, 399, 515 and 639 cm⁻¹ positions. According to the above description, it could be seen that high crystallinity titanium dioxide nanoparticles in the porous graphene sample were deposited on the surface of a graphene layer while maintaining excellent crystallinity without affecting of the strong carbon-oxygen-titanium bond upon a change in graphene structure on the surface of the graphene layer. Further, as shown in FIG. 5, it could be seen that porosity was observed at a temperature of 77K through various electron microscopy analyses, in particular, nitrogen gas adsorption/desorption analysis on the surface of the porous graphene-titanium dioxide nanoparticle structure. Whether there are mesopores in the porous graphene-titanium dioxide nanoparticle structure, was obviously demonstrated from hysteresis isothermal curves (type IV) as shown in FIG. 6(e). Based on isothermal desorption behavior, a pore size distribution diagram was prepared according to a Barrett-Joyner-Halenda (BJH) method, as shown in FIG. 6(f). From the diagram, a clear peak corresponding to the pore having a diameter of about 3.7 nm was observed. This corresponds to an interval between the titanium dioxide nanoparticles present on the surface of the porous graphene, and it could be seen that the porous graphene network structure in a three-dimensional shape may function as a support to help the deposition of titanium dioxide nanoparticles in a thin film form while inhibiting coagulation thereof, as shown in FIG. 3.

As described above, after growing the graphene using a catalyst to synthesize a graphene structure in a network form, and then, synthesizing a colloidal solution of metal oxide nanoparticles, these metal oxide nanoparticles are deposited on a graphene support in a uniform thin film form in order to form a porous graphene-metal oxide nanoparticle layer structure, in turn, being used for preparing a negative electrode material for a lithium secondary battery. Using such the prepared negative electrode material, a lithium secondary battery may be fabricated.

The present invention discloses a technique for synthesis of a layer structure composed of a porous graphene having different pores in a three-dimensional shape and metal oxide nanoparticles, which exhibit noticeably improved characteristics in lithium secondary battery applications, therefore, may substitute for the conventional electrodes manufactured using carbon, silicon and other metallic materials. In particular, this structure may be fully charged and discharged within one minute and have a long cycle life of 10,000 cycles or more, and may achieve remarkably superior performance, efficiency and characteristics over the conventional secondary batteries based on metal oxide. Accordingly, the present invention may also be applied in the next generation technical fields requiring high output power and stability. Therefore, it is anticipated that the present invention possesses great practical value in an aspect of commercial utilization. Further, the RTCVD system, which is used in the subsidiary processes and can execute fast heat treatment, may considerably reduce a process time while achieving mass production more easily. Therefore, when the present invention is applied to an industrial field that utilizes the conventional graphene, great effects may be expected. The structure of the present invention has purposes of compensating low conductivity of the metal oxide particles and, at the same time, inhibiting coagulation of the particles having a very small size. The present invention is based on a principle that a structure having pores of a three-dimensional shape is formed to increase a surface area while remarkably enhancing accessibility to a reactive material. Therefore, the present invention is also applicable to other energy storage devices such as a capacitor, which are operating with a principle similar to the secondary battery. In addition thereto, the present invention may be used in a broad range of applications including, for example, substrates of various flexible devices, a water-decomposition catalyst of a fuel cell, a solar energy conversion catalyst utilizing a metal oxide semiconductor, and the like.

What is claimed is:

1. A method for manufacturing a negative electrode material for a lithium secondary battery, using a layer structure of porous graphene and metal oxide nanoparticles, the method comprising; synthesizing a graphene structure in a network form by growing the graphene with a catalyst; synthesizing a colloidal solution of metal oxide nanoparticles; and depositing the metal oxide nanoparticles on the porous graphene structure in a thin film form.

2. The method according to claim 1, wherein an RTCVD system used for the growth and synthesis of the graphene structure includes a heating zone, a cooling zone, and a screw bar-shaped moving part disposed at a lower end of a heater, wherein the heater is operated while moving between the heating zone and the cooling zone to reduce a temperature elevation time and a cooling time.

3. The method according to claim 2, wherein, when a sample is placed in a chamber, the heating zone is heated to a temperature of 900 to 1,100° C. while flowing an argon/hydrogen gas therein under a vacuum state, the graphene is grown while flowing a methane gas therethrough, and then, the heating zone rapidly moves to its original position and cooled to a temperature of 190 to 210° C. within 4 to 6 minutes.

4. The method according to claim 1, wherein the catalyst includes a nickel foam, and the sample containing the grown graphene is put in hydrochloric acid and treated to remove the nickel catalyst at a temperature of 60 to 80° C. for 5 to 7 hours.

5. The method according to claim 1, wherein the colloidal solution of metal oxide nanoparticles is prepared by hydrothermal synthesis, so as to form a colloidal state of titanium dioxide nanocrystals having a diameter of 4 to 10 nm.

6. The method according to claim 1, wherein a combination of the porous graphene and the metal oxide nanoparticles is formed by depositing titanium dioxide nanoparticles on the graphene structure in a three-dimensional network form by a drop-casting method, and then, heating the same at a temperature of 430 to 470° C., so as to deposit the nanoparticles thereon in a uniform thin film form.

7. The method according to claim 1, wherein the graphene has a conductivity of 900 to 1100 s/m, and is a network form having macropores with a size of 40 to 60 μm in a three-dimensional shape and a width ranging from 15 to 25 μm.

8. The method according to claim 1, wherein the metal oxide nanoparticle has open mesopores having a size of 2 to 8 nm.

9. The method according to claim 1, wherein the metal oxide is made of any one or two or more elements selected from a group consisting of V, Cr, Mn, Fe, Co, Ni, Cu, Zn, Si, Ga, Ge, Zr, Nb, Mo, Sn, Sb, W and Ce as well as Ti.

10. A negative electrode material for a lithium secondary battery prepared according to any one of claims 1 to 7.

11. The negative electrode material according to claim 10, wherein the negative electrode material is in a round thin film form having a diameter of 0.7 to 0.9 cm and a thickness of 0.2 to 0.4 mm, and prepared using a layer structure of porous graphene and metal oxide nanoparticles.

12. A lithium secondary battery fabricated using the negative electrode material according to any one of claims 10 and 11.
